(19) United States
(12) Patent Application Publication
(10) Pub. No.: US 2024/0219113 A1
(43) Pub. Date: Jul. 4, 2024

(54) METHOD AND SYSTEM FOR AVOIDING FREEZING OF AT LEAST ONE COMPONENT OF A CRYOGENIC FLUID INSIDE A CRYOGENIC HEAT EXCHANGER

(71) Applicant: Cryostar SAS, Hesingue (FR)

(72) Inventors: Guillaume PAGES, Hesingue (FR); Nicolas BRUNNER, Hesingue (FR)

(21) Appl. No.: 18/563,616

(22) PCT Filed: Jun. 20, 2022
(86) PCT No.: PCT/EP2022/025283

§ 371 Date: Nov. 22, 2023

(30) Foreign Application Priority Data
Jun. 21, 2021 (EP) 21315097.2

(51) Int. Cl. F25J 1/02; F25J 1/00

(52) U.S. Cl. CPC F25J 1/0254; F25J 1/0025; F25J 1/005; F25J 1/0204; F25J 1/0277; F25J 1/0072; F25J 2280/40; F25J 2290/34

(57) ABSTRACT

The invention relates to a method and to a system for avoiding freezing of at least one component of a cryogenic fluid inside a cryogenic heat exchanger by measuring a physical property allowing to indirectly determine the risk of freezing of the least one component of the cryogenic fluid inside the cryogenic heat exchanger.

The present invention relates to a method and a system for avoiding freezing of at least one component of a cryogenic fluid stream inside a cryogenic heat exchanger.

The invention also relates to the use of the method onboard a sea-going LNG carrier and to a ship comprising a system according to the invention.

The invention is of particular relevance for the transport of natural gas in liquid form especially in sea-going LNG tankers and is primarily described herein with the reference to this application. It is, however, to be understood that it is also applicable to other cryogenic liquids or cryogenic liquid mixtures.

### STATE OF THE ART

LNG is normally liquefied and transported at −162° ° C. Before being liquefied, the natural gas is treated to remove components that could freeze at this temperature like heavier hydrocarbon having more than six carbon atoms, benzene and aromatics, carbon dioxide, water etc . . . .

After removal of these components, a stream of dry and lean natural gas is obtained, mainly comprising the components methane, ethane, propane, butane, along with a few mole percent of nitrogen.

However, according to the internal knowledge and processing of the applicant, for economic reasons, the above mentioned components that could freeze at −162° C. are not completely removed, but merely to such an extent to avoid freezing at −162° C. with a reasonable safety margin, but not enough to avoid freezing at significantly colder temperatures, because it was not necessary as −162° C. used to be the coldest temperature of the whole LNG transportation chain.

While natural gas is conveniently stored and transported in liquid state in LNG storage tanks on board of LNG carriers, heat ingress is inevitable although LNG carrier's tanks are especially designed to minimize the heat ingress from the outside environment into the bulk LNG transported within one or more LNG tanks of the ship.

During its transportation at sea by LNG carriers, due to the unavoidable heat ingress into the LNG storage tanks, a part of the LNG evaporates, known as Boil-Off Gas (BOG). This BOG flow is used as fuel for the motors of the ship. However, it can be that the evaporation is higher than the demand from the motors, resulting in a loss of cargo as not all the BOG can be used as fuel for the motors and must then be disposed by incineration.

To avoid this excessive evaporation, more and more LNG carriers are equipped with subcoolers, located outside the LNG storage tanks, for subcooling the LNG. Subcooling means to cool down a liquid to a temperature below its condensation point, at a given pressure

Subcoolers are cryogenic refrigeration systems using the compression, cooling and expansion of a refrigerant stream to create cold energy, which is then transferred to the LNG stream withdrawn from the storage tank in a cryogenic heat exchanger by indirect heat exchanger with the refrigerant stream.

Thus, the excessive heat ingress can be compensated by cooling, preferably subcooling, a part of the LNG. This is achieved by pumping a flow of LNG from a storage tank of the ship, (sub-) cooling the LNG stream in a so-called “subcooler”, and then re-injecting the (sub-) cooled LNG stream inside the storage tank.

To compensate for the heat ingress, the LNG shall be subcooled down to ca. −175° C., a temperature level significantly colder than the −162° C. usually found along the whole LNG chain. Locally inside the cryogenic heat exchanger of the subcooler, the wall temperature may even reach a temperature of −178° C. The LNG being only treated to avoid freezing at −162° C., there is a risk of freezing of some components of the LNG because of the significantly colder temperature inside the cryogenic heat exchanger of subcooler.

WO 2021023457 A1 discloses a method where the subcooler is stopped in its operation and the cryogenic heat exchanger is cleaned by circulating LNG from a LNG storage tank to melt the frozen components.

A first disadvantage of this method is that the cryogenic heat exchanger before being defrosted, already suffers from a decrease of its efficiency because of the increasing pressure drop and decreasing heat transfer due to freezing of components which continuously take place before the defrosting step is initialized.

Another disadvantage of this method is that the subcooler must be stopped during the cleaning step, resulting in a potential partial loss of LNG due to the evaporation of LNG.

It is therefore an object of the present invention to provide a method and a system to overcome the above-mentioned disadvantages of the prior art.

### SUMMARY OF THE PRESENT INVENTION

This object is solved by a method for avoiding freezing of at least one component of a cryogenic fluid stream inside a cryogenic heat exchanger according to claim 1, a system for avoiding freezing of at least one component of a cryogenic fluid stream inside a cryogenic heat exchanger according to claim 8, to the use of the method onboard a sea-going LNG carrier according to claim 13 and to a ship comprising a system according to claim 14.

According to the present invention there is provided a method for avoiding freezing of at least one component of a cryogenic fluid stream inside a cryogenic heat exchanger indirectly exchanging heat with a first refrigerant stream circulating inside a closed refrigeration loop and entering the cryogenic heat exchanger after expansion through at least one expansion means of the closed refrigeration cycle to indirectly exchange heat with the cryogenic fluid, the cryogenic fluid stream being different from the first refrigerant stream, that is to say that the cryogenic fluid stream and the first refrigerant stream are two different fluids having different chemical compositions preferably not having at least one common component and comprising the steps of:
Withdrawing and vaporizing a partial stream of the cryogenic fluid stream which is to be fed into the cryogenic heat exchanger,
Measuring at least one physical property of a vaporized partial stream of the cryogenic fluid, the at least one physical property measured being an indirect indicator of the risk of freezing of the at least one component of the cryogenic fluid inside the cryogenic heat exchanger. The term physical property is intended to mean a property for the measurement of which an exhaustive determination of the chemical composition of the fluid is not necessary. Physical property is thus to be understood in the context of this invention as being different from the chemical analysis of the fluid, the various concentrations thus being chemical properties of the fluid. Because of the increase of the concentrations of ethane, propane, and butane in the LNG, they also increase in the vaporized part of it. The physical property is an indirect indicator of the risk of freezing because an increase of the value of the physical property reflect an increase of its concentration within the LNG and thus an increase of the risk of freezing inside the cryogenic heat exchanger. In that way, it is advantageously possible to determine the risk of freezing without resorting to the use of expensive gas analyzers like gas chromatographs or spectrometers.
Transmitting the measurement of the at least one physical property to computing means. The transmission of the measured physical properties can be done by wire communication or by radio-communication like Wi-Fi or even to a remote receptor via satellite communication.
Determining by the computing means if there is a risk of freezing of the at least one component of the cryogenic fluid stream inside the cryogenic heat exchanger based on the transmitted measurement. The determination of the likelihood of freezing can be done by calculation on a computer configured for or by a software embedded within the ship control system. The determination can also be done remotely by a computer distant from the ship in which the measurement is taking place.
If the risk of freezing is confirmed, increasing the temperature of the first refrigerant stream entering the cryogenic heat exchanger to indirectly exchange heat with the cryogenic fluid stream.

The first refrigerant stream entering the cryogenic heat exchanger to indirectly exchange heat with the cryogenic fluid stream can be the stream of refrigerant after expansion through expansion means of a closed refrigeration loop.

The risk of freezing of the at least one component of the cryogenic fluid can be confirmed if the transmitted measurement is within a freezing range calculated by the computing means at the temperature of the first refrigerant stream entering the cryogenic heat exchanger (9) to indirectly exchange heat with the cryogenic fluid.

In a preferred embodiment the at least one physical property is chosen from a group comprising the thermal conductivity (e.g. measured in W·m⁻¹·K⁻¹), the speed of sound (e.g. measured in m·s⁻¹), the density (e.g. measured in kg·m⁻³), the electrical conductivity (e.g. measured in S·m⁻¹), the heating value (e.g. measured in kJ·kg), the Wobbe index (e.g. measured in MJ·m⁻³).

The Wobbe index is an indicator of the interchangeability of a fuel gas and is defined as the heating value divided by the square root of the relative density of the gas.

During transportation of the LNG, the boil-off gas evaporating from the tanks and being used as fuel for the motors of the ship has concentrations of nitrogen and methane higher than the concentrations of these two components in the transported LNG. Because of this, the LNG remaining within the tanks gets slowly depleted in methane and nitrogen and thus richer and richer in high boiling points and prone to freezing components like CO2, ethane, propane and butane. Ethane, propane and butane having higher heating values than nitrogen and methane, during the length of the transportation, the overall heating value of the LNG remaining within the tanks increases over time thus developing a risk of freezing of these components inside the cryogenic heat exchanger of the subcooler because their concentrations in the LNG can increase above their solubility limit. The measured physical property thus indirectly indicates the risk of freezing of the LNG. Despite exemplified with the heating value for the sake of clarity, this also applies to the others above cited physical properties.

It is then particularly convenient to measure at least one of these properties with simple instruments named gas properties transmitters for example such as the model “gasPT” from the company Orbital, as it is not necessary to use a complex gas analyzer to exhaustively determine the chemical composition of the vaporized LNG for estimating the freezing point of the at least one component.

In another preferred embodiment, the temperature of the first refrigerant stream entering the cryogenic heat exchanger to indirectly exchange heat with the cryogenic fluid stream is increased by decreasing the mass flow of the first refrigerant stream circulating within a closed loop and entering the cryogenic heat exchanger to indirectly exchange heat with the cryogenic fluid. Hence, the risk of freezing of the cryogenic fluid inside the cryogenic heat exchanger is avoided.

Optionally, the cryogenic heat exchanger can be splitted into two separate heat transfer stages, where in a first heat transfer stage only heat from the cryogenic fluid is indirectly transferred to the first refrigerant stream and where in a second heat transfer stage the first refrigerant stream exchanges heat only with a second refrigerant stream. The first refrigerant stream is the refrigerant stream exiting the expansion means of the closed refrigeration loop and therefore is the coldest and lowest pressure stream of the closed refrigeration loop. The second refrigeration stream is the stream exiting the aftercooler located at the outlet of the latest compression stage of the closed refrigeration loop and is therefore a high pressure, nearly ambient temperature stream.

In a further embodiment, the refrigerant being put in motion inside the refrigeration loop by one or several refrigerant compressors, the mass flow of the first refrigerant stream entering the cryogenic heat exchanger to indirectly exchange heat with the cryogenic fluid can be decreased by decreasing the speed of rotation of at least one compressor which forces the first refrigerant stream into the heat exchanger, in particular which circulates the refrigerant stream within a closed refrigeration loop comprising the cryogenic heat exchanger.

Optionally, the temperature of the first refrigerant stream entering the cryogenic heat exchanger can be increased by bypassing around the cryogenic heat exchanger a partial stream of a second refrigerant stream which enters the heat exchanger at a pressure higher than the pressure of the first refrigerant stream, both first and second refrigerant streams being circulated within the same closed refrigeration loop. Bypassing part of the second refrigerant stream around the cryogenic heat exchanger is performed by branching off a part of the refrigerant before the inlet of the high pressure refrigerant side of the heat-exchanger, and instead of circulating that part inside said side, circulating it in a separate line where the refrigerant cannot exchange heat with the cryogenic fluid and with the low pressure refrigerant. The flow of the part of the refrigerant bypassing the heat exchanger in the separate line is controlled with a flow control valve located on the separate by-pass line. The flow control valve is open or closed in a manner to ensure that the temperature of the refrigerant inside the cryogenic heat exchanger is above the determined freezing range of the cryogenic fluid.

Optionally, in addition to the measurement of at least one physical property of the cryogenic fluid, the pressure drop across the cryogenic heat exchanger on the side of the cryogenic fluid stream can be measured, transmitted to the computing means and used for determining the risk of freezing of at least one component of the cryogenic fluid stream inside the cryogenic heat-exchanger. This additional measurement of the pressure drop across the heat exchanger, being independent from the measurement of a physical property of a cryogenic fluid, acts as a second layer of protection against freezing of the cryogenic fluid inside the cryogenic heat exchanger. The value of the pressure drop can then be compared to the at least one physical property of the cryogenic fluid to avoid false positives thus rendering the method more reliable. The risk of freezing of the at least one component of the cryogenic fluid stream is determined by the computing means by selecting the highest of the normalized value of a signal proportional to the measurement of a physical property of a cryogenic fluid transmitted by the gas properties transmitter and a normalized signal transmitted by the means for measuring the pressure drop across the cryogenic heat exchanger on the cryogenic fluid side. Both signals could be normalized for example on a 4 to 20 mA scale in the case of transmission of electrical signals by wires, or can be normalized on a 0.2 to 1 bar scale in the case of transmission of a pneumatic signal. Once normalized on the same scale, i.e. 4-20 mA or 0.2-1 bar, the normalized signal having the highest value is selected for determining the risk of freezing. If the normalized signal corresponding to the measured pressure drop across the cryogenic heat exchanger on the cryogenic fluid side is selected, then the risk of freezing is determined by comparing the measured normalized value of the pressure drop with a another normalized value of the pressure drop across the heat exchanger corresponding to the maximum allowable pressure drop across the heat exchanger. If the measured value is higher than the maximum allowable pressure drop, then a risk of freezing is confirmed.

According to a second aspect, the present invention relates to a system comprising a cryogenic heat exchanger, a compressor and computing means for avoiding freezing of at least one component of a cryogenic fluid stream inside a cryogenic heat exchanger indirectly exchanging heat with a first refrigerant stream entering the cryogenic heat exchanger to indirectly exchange heat with the cryogenic fluid, comprising:
A gas conditioning system for vaporizing a partial stream being withdrawn from the cryogenic fluid stream upstream of the heat exchanger;
A gas properties transmitter configured to measure at least one physical property of the cryogenic fluid, the at least one physical property being an indirect indicator of the risk of freezing of at least one component of the cryogenic fluid stream inside the cryogenic heat exchanger. Gas properties transmitters are well-known, compact and simple instruments that are commonly used to monitor the quality of natural gas transiting through pipelines without any supervision and only require a minimal amount of maintenance. Advantageously, this avoids the use of chromatographs or spectrometers that are very costly, take a lot of space and are difficult to operate onboard a sea-going vessel;
Means for transmitting a measurement of the at least one physical property measured by the gas properties transmitter to the computing means. The transmission means for transmitting the measurement of the at least one physical property can be wires or pneumatic lines. The computing means are configured to determine the risk of freezing of at the least one component of the cryogenic fluid inside the heat exchanger from the transmitted measurement of the at least one physical property of the cryogenic fluid. The computing means can be a computer located onboard the LNG carrier but they can also be integrated within the ship control and command system. They can also be cloud-computing means in the case of a remote determination. If the computing means are located remotely from the ship, the transmission means can be radio-emissions or means of satellite communication.
Means for increasing the temperature of the first refrigerant stream entering the cryogenic heat exchanger to indirectly exchange heat with the cryogenic fluid stream.

In a preferred embodiment, wherein the at least one physical property measured by the gas properties transmitter is chosen from a group comprising the thermal conductivity, the speed of sound, the density, the electrical conductivity, the Wobbe index, the heating value.

Optionally, the means for increasing the temperature of the first refrigerant stream comprise at least one variable frequency drive for adjusting the speed of rotation of at least one compressor which forces the first refrigerant stream into the cryogenic heat exchanger, in particular which circulates the first refrigerant stream inside a closed refrigeration loop comprising the heat exchanger.

Additionally, the means for increasing the temperature of the first refrigerant stream comprise a bypass line with a by-pass valve adapted for bypassing a partial stream of a second refrigerant stream around the cryogenic heat exchanger, both first and second refrigerant streams being circulated within the same closed refrigeration loop (100).

In a another embodiment, the reliability of the system can be improved by means for measuring the pressure drop across the cryogenic heat exchanger on the side of the cryogenic fluid stream, the risk of freezing of the at least one component of the cryogenic fluid stream inside the cryogenic heat exchanger being determined by the computing means being configured for using the pressure drop across the cryogenic heat exchanger on the side of the cryogenic fluid stream to determine the risk of freezing of the at least one component of the cryogenic fluid stream inside the cryogenic heat exchanger. The risk of freezing of the at least one component of the cryogenic fluid stream is determined by the computing means by selecting the highest of the normalized value of a signal proportional to the measurement of a physical property of a cryogenic fluid transmitted by the gas properties transmitter and a normalized signal transmitted by the means for measuring the pressure drop across the cryogenic heat exchanger. Both signals could be normalized for example on a 4 to 20 mA scale in the case of transmission of electrical signals by wires, or can be normalized on a 0.2 to 1 bar scale in the case of transmission of a pneumatic signal. Once normalized on the same scale, i.e. 4-20 mA or 0.2-1 bar, the normalized signal having the highest value is selected for determining the risk of freezing. If the normalized signal corresponding to the measured pressure drop across the cryogenic heat exchanger on the cryogenic fluid side is selected, then the risk of freezing is determined by comparing the measured normalized value of the pressure drop with a another normalized value of the pressure drop across the heat exchanger corresponding to the maximum allowable pressure drop across the heat exchanger. If the measured value is higher than the maximum allowable pressure drop, then a risk of freezing is confirmed.

A third aspect for which protection is sought, but which also represents an embodiment of the present invention according to the first aspect, is directed to the use of the method for avoiding the freezing of at least one component of a cryogenic fluid stream inside a cryogenic heat exchanger indirectly exchanging heat with a refrigerant stream inside the cryogenic heat exchanger according to claims 1 to 7 onboard a sea-going LNG carrier.

A fourth aspect for which protection is sought, but which also represents an embodiment of the present invention according to the second aspect, is directed to a ship comprising a system according to any of claims 8 to 13.

Preferably, the ship is a LNG carrier.

Regarding further explanations as to the advantages of the compressor arrangement and its embodiments, reference is explicitly made to the statements in connection with the method according to the present invention above.

Further advantages and preferred embodiments of the invention are disclosed in the following description and FIGURES.

It is understood by a person skilled in the art that the preceding and the following features are not only disclosed in the detailed combinations as discussed or showed in a figure, but that also other combinations of the features can be used without exceeding the scope of the present invention.

The invention will now be further described with reference to the accompanying drawings showing preferred embodiments.

### BRIEF DESCRIPTION OF THE DRAWINGS

FIG. 1 schematically shows a first embodiment of the invention wherein a first refrigerant stream enters the heat exchanger to indirectly exchange heat with the cryogenic fluid stream.

FIG. 2 schematically shows a second embodiment of the invention wherein the temperature of the refrigerant is increased by decreasing the speed of rotation of at least one compressor.

FIG. 3 schematically shows a third embodiment of the invention wherein the temperature of the refrigerant is increased by bypassing part of the refrigerant around the cryogenic heat exchanger.

FIG. 4 schematically shows a fourth embodiment of the invention which is essentially based on the first embodiment, with the addition of means for measuring the pressure drop across the cryogenic heat exchanger.

FIG. 5 schematically shows a fifth embodiment of the invention which is essentially based on the second embodiment, with the addition of means for measuring the pressure drop across the cryogenic heat exchanger.

### DETAILED DESCRIPTION OF THE DRAWINGS

In the following, the different embodiments according to the Figures are discussed comprehensively, same reference signs indicating same or essentially same units. It is appreciated that a person skilled in the art may combine certain components of an embodiment shown in a figure with the features of the present invention as defined in the appended claims without the need to include more than this certain component or even all other components of this embodiment shown in said figure. In other words, the following FIGURES show different preferable aspects of the present invention, which can be combined to other embodiments. The embodiments shown in the FIGURES all relate to the application of determining the risk of freezing and avoiding freezing of a cryogenic fluid indirectly exchanging heat with a refrigerant inside a cryogenic heat exchanger comprising onboard a LNG carrier, but it is appreciated that a person skilled in the art can easily transfer the embodiments to applications involving other cryogenic gases or gas mixtures.

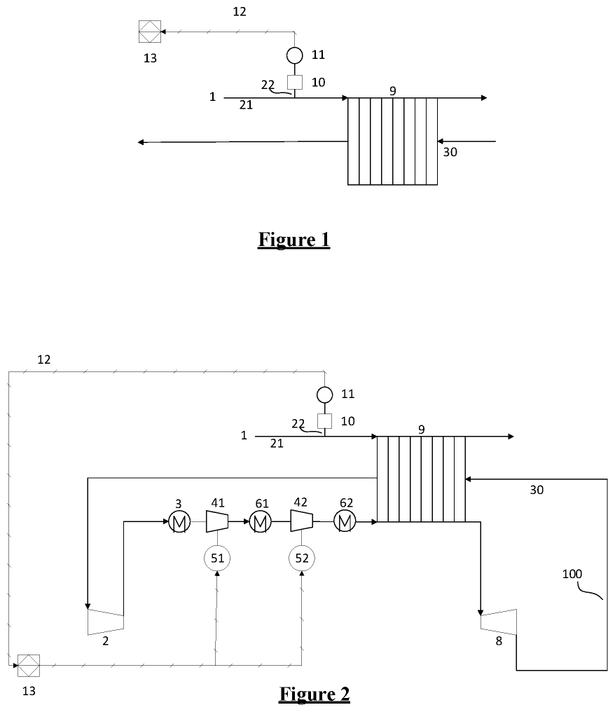

FIG. 1 shows a first embodiment of a method and a system for avoiding freezing of a cryogenic fluid stream 1 inside a cryogenic heat exchanger 9 indirectly exchanging heat with a first refrigerant stream 30 inside the cryogenic heat exchanger 9.

In this example, the cryogenic fluid stream 1 is LNG stored at a temperature of for example about −162° C. inside a cryogenic tank of a sea-going vessel (both not shown). LNG is typically composed of nitrogen, methane, ethane, propane, butane with ppmv level traces of benzene, carbon dioxide and water. During its transportation, because of the unavoidable heat-ingress inside the storage tank, a part of the LNG evaporates. This evaporation gas from the LNG is known as Boil-Off-Gas (BOG).

Nitrogen and methane being the components of the LNG with the lowest boiling temperatures, the concentrations of these two components in the BOG is higher than their concentration in the LNG. As a result, the concentrations of the other components (ethane, propane, etc. . . . ) in the LNG are increasing over the duration of the journey of the ship, thus increasing the risk of freezing of at least one component of the LNG stream 1 inside the heat exchanger 9, thus deteriorating the performance of the cryogenic heat exchanger, and ultimately risking a complete blocking of the heat exchanger 9.

A partial stream of the LNG stream 1 from a line 21 originating from the cryogenic LNG tank (no shown) is branched off upstream of the heat exchanger 9 into line 22 and then vaporized in a gas conditioning system 10. In addition to a vaporizing component (not shown), the conditioning system 10 typically includes a flow regulator, a pressure regulator and a heater (all three components not shown) to provide a small flow of vaporized LNG at controlled and stables conditions to a properties transmitter 11.

The properties transmitter 11 measures one or several physical properties/property of the vaporized cryogenic fluid, like for example thermal conductivity (e.g. measured in W·m⁻¹·K⁻¹), speed of sound (e.g. measured in m·s⁻¹), density (e.g. measured in kg·m⁻³), electrical conductivity (e.g. measured in S·m⁻¹), heating value (e.g. measured in kJ·kg), Wobbe index (e.g. measured in MJ·m⁻³). As an example, the physical property heating value (e.g. measured in kJ/kg) will be considered in the following discussion, but this also apply to the others physical properties cited above. Ethane, propane, and butane having higher heating values than methane and nitrogen, their overall concentration increase in the LNG can thus be indirectly determined by measuring the heating value of the vaporized part. Because these components also have higher boiling points than nitrogen and methane, it is then possible to determine the risk of freezing of the cryogenic fluid from one of the physical property, like heating value in the example, of the LNG without resorting to an exhaustive chemical analysis of the cryogenic fluid.

Once at least one physical property of the cryogenic fluid has been measured by the properties transmitter 11, the measurement is transmitted via means of transmission 12 to computing means 13 for determining the risk of freezing of the cryogenic fluid.

Based on the measured value of the physical property, the computing means 13 determines the risk of freezing. If the measured value of the at least one physical property of the cryogenic fluid is within a range calculated by the computing means at the temperature of a first refrigerant stream 30 entering the cryogenic heat exchanger 9 to indirectly exchange heat with the cryogenic fluid 1 and corresponding to the freezing of the at least one component of the cryogenic fluid, then the risk of freezing is confirmed.

If the risk of freezing is confirmed, freezing can then be avoided for example by slightly increasing the temperature of the first refrigerant stream 30 entering the cryogenic heat exchanger 9 to indirectly exchange heat with the cryogenic stream 1 to increase the temperature of the cryogenic fluid above its freezing point.

The first refrigerant stream 1 can be for example composed of liquid nitrogen supplied from a liquid nitrogen tank.

FIG. 2 shows a second embodiment of a method and a system for avoiding freezing of a cryogenic fluid stream 1 inside a cryogenic heat exchanger 9 indirectly exchanging heat with a first refrigerant stream 30 inside the cryogenic heat exchanger 9.

The refrigerant is circulating inside a closed refrigeration cycle 100 comprising the steps of compression of the refrigerant for example by first, second and third compressor 2; 41; 42, after each compression step the refrigerant is cooled by first, second and third aftercooler 3; 61; 62 to remove from the refrigerant the heat generated by compression. After being cooled by the third aftercooler 62, the high-pressure refrigerant enters the heat exchanger 9 as a second refrigerant stream to be further cooled in heat exchanger 9, and then expanded by an expansion means 8 to a low temperature, low-pressure first refrigerant stream 30. Typically, as for LNG refrigeration systems, the expansion means 8 can be a turbine 8. Then the low-pressure first refrigerant stream 30 exchanges heat in the heat exchanger 9 with both the high-pressure second refrigerant stream from the for example third aftercooler 62 and the cryogenic fluid stream 1 to be (sub-)cooled.

In this example, the cryogenic fluid stream 1 is LNG stored at a temperature of for example about −162° C. inside a cryogenic tank of a sea-going vessel (both not shown). LNG is typically composed of nitrogen, methane, ethane, propane, butane with ppmv level traces of benzene, carbon dioxide and water. During its transportation, because of the unavoidable heat-ingress inside the storage tank, a part of the LNG evaporates. This evaporation gas from the LNG is known as Boil-Off-Gas (BOG).

Nitrogen and methane being the components of the LNG with the lowest boiling temperatures, the concentrations of these two components in the BOG is higher than their concentration in the LNG. As a result, the concentrations of the other components (ethane, propane, etc. . . . ) in the LNG are increasing over the duration of the journey of the ship, thus increasing the risk of freezing of at least one component of the LNG stream 1 inside the heat exchanger 9, thus deteriorating the performance of the cryogenic heat exchanger, and ultimately risking a complete blocking of the heat exchanger 9.

A partial stream of the LNG stream 1 from a line 21 originating from the cryogenic LNG tank (no shown) is branched off upstream of the heat exchanger 9 into line 22 and then vaporized in a gas conditioning system 10. In addition to a vaporizing component (not shown), the conditioning system 10 typically includes a flow regulator, a pressure regulator and a heater (all three components not shown) to provide a small flow of vaporized LNG at controlled and stables conditions to a properties transmitter 11.

The properties transmitter 11 measures one or several physical properties/property of the vaporized cryogenic fluid, like for example thermal conductivity (e.g. measured in W·m⁻¹·K⁻¹), speed of sound (e.g. measured in m·s⁻¹), density (e.g. measured in kg·m⁻³), electrical conductivity (e.g. measured in S·m⁻¹), heating value (e.g. measured in kJ·kg), Wobbe index (e.g. measured in MJ·m⁻³). As an example, the physical property heating value (e.g. measured in kJ/kg) will be considered in the following discussion, but this also apply to the others physical properties cited above. Ethane, propane, and butane having higher heating values than methane and nitrogen, their overall concentration increase in the LNG can thus be indirectly determined by measuring the heating value of the vaporized part. Because these components also have higher boiling points than nitrogen and methane, it is then possible to determine the risk of freezing of the cryogenic fluid from one of the physical property, like heating value in the example, of the LNG without resorting to an exhaustive chemical analysis of the cryogenic fluid.

Once at least one physical property of the cryogenic fluid has been measured by the properties transmitter 11, the measurement is transmitted via means of transmission 12 to computing means 13 for determining in the risk of freezing of the cryogenic fluid.

Based on the measured value of the physical property, the computing means 13 determines the risk of freezing. If the measured value of the at least one physical property of the cryogenic fluid is within a range calculated by the computing means at the temperature of the first refrigerant stream 30 entering the cryogenic heat exchanger 9 to indirectly exchange heat with the cryogenic fluid 1 and corresponding to the freezing of the at least one component of the cryogenic fluid, then the risk of freezing is confirmed.

If the risk of freezing is confirmed, freezing can then be avoided for example by slightly increasing the temperature of the first refrigerant stream 30 entering the cryogenic heat exchanger 9 to indirectly exchange heat with the cryogenic stream 1 to increase the temperature of the cryogenic fluid above the freezing point of the cryogenic fluid.

To do so, in the embodiment of FIG. 2, the temperature of the refrigerant stream 30 entering the heat exchanger 9 to indirectly exchange heat with the cryogenic fluid stream 1 is increased by decreasing the mass flow of the first refrigerant stream indirectly exchanging heat with the cryogenic fluid. As the cryogenic refrigeration cycle 100 is a closed loop, if the flow of refrigerant stream is decreased within the cycle 100, the heat transfer between the cryogenic fluid 1 and the first refrigerant stream is reduced, the cryogenic fluid 1 is less subcooled and thus its temperature increases until it becomes warmer than the freezing point of the cryogenic fluid, thus effectively avoiding freezing within the heat exchanger 9. As the cycle 100 comprises means for compression the refrigerant stream 30, for example third compressors 2; 41; 42 arranged in series, for putting the refrigerant in motion within the thermodynamic cycle 100, the mass flow of refrigerant stream 30 can conveniently be reduced by reducing the speed of rotation of at least one of the compressors 41; 42 with their respective variable frequency drives 51; 52. The variable frequency drives are commanded by the computing means 13 according to the risk of freezing of the cryogenic fluid 1 inside the cryogenic heat exchanger 9. If a risk of freezing is determined to be within the freezing range by the computing means13, freezing is then avoided by the computing means 13 sending a command to reduce speed of rotation of at least one compressor 41; 42 to their respective variable frequency drives 51; 52.

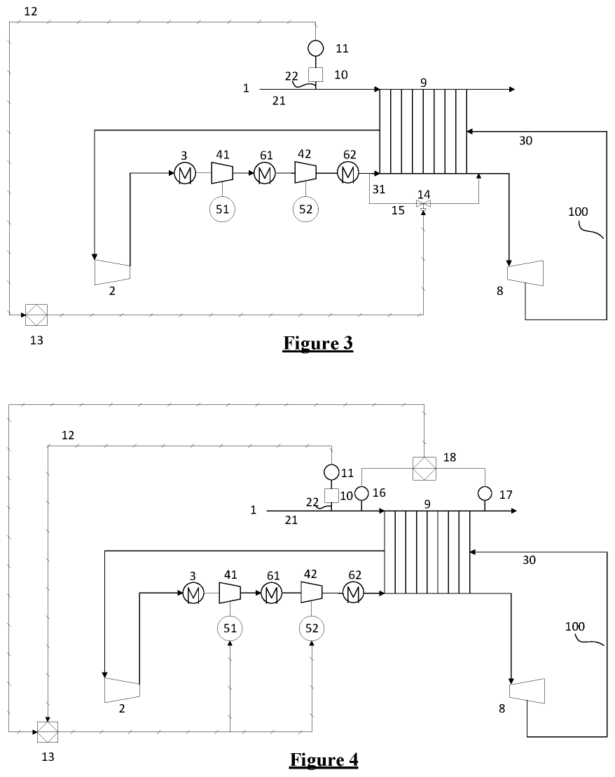

FIG. 3 shows third embodiment, which only differs from the embodiment of FIG. 2 in the way and means used to decrease the mass flow (e.g. measured in kg/s) of the first refrigerant stream 30. In this second embodiment, instead of decreasing the speed of rotation of the refrigerant compressor means 41; 42, a partial stream 31 of the high pressure second refrigerant stream exiting aftercooler 62 is branched off upstream of the heat exchanger 9 into a by-pass line 15. The residual stream 32 is entering the heat exchanger 9. Thus, the temperature of the first refrigerant stream entering the heat exchanger 9 to indirectly exchange heat with the cryogenic fluid stream 1 is increased. The flow of refrigerant stream 31 passing through by-pass line 15 is adjusted with control valve 14. The adjustable opening and closure of control valve 14 is commanded by the computing system 13 according to the risk of freezing of the cryogenic fluid 1 inside the cryogenic heat exchanger 9. This third embodiment advantageously allows to regulate the flow of refrigerant, and then to avoid freezing, without having to use the expensive variable frequency drives 51; 52 of the second embodiment.

FIG. 4 schematically shows a fourth embodiment of the invention that is essentially based on the second embodiment, with the addition of means 16; 17; 18 for measuring the pressure drop across the cryogenic heat exchanger 9. The pressure drop across the cryogenic heat exchanger 9 on the side of the cryogenic fluid stream is measured by subtracting with differential pressure transmitter 18 the pressure at the outlet of the passage of the cryogenic fluid stream in the cryogenic heat exchanger 9 from pressure probe 17 to the pressure at the inlet of the passage of the cryogenic fluid in the cryogenic heat exchanger 9 from pressure probe 16. The differential pressure measured by the pressure transmitter 18 is then transmitted to and used by the computing means 13 for determining the risk of freezing of the cryogenic fluid inside the cryogenic heat exchanger. This additional measurement of the pressure drop across the heat exchanger, being independent from the measurement of a physical property of a cryogenic fluid, acts as a second layer of protection against freezing of the cryogenic fluid inside the cryogenic heat exchanger. The normalized value value of the pressure drop can then be compared to the normalized value of at least one physical property of the cryogenic fluid to avoid false positives thus rendering the method more reliable. Once normalized on the same scale, i.e. 4-20 mA or 0.2-1 bar, the normalized signal having the highest value is selected for determining the risk of freezing. If the normalized signal corresponding to the measured pressure drop across the cryogenic heat exchanger on the cryogenic fluid side is selected, then the risk of freezing is determined by comparing the measured normalized value of the pressure drop with a another normalized value of the pressure drop across the heat exchanger corresponding to the maximum allowable pressure drop across the heat exchanger. If the measured value is higher than the maximum allowable pressure drop, then a risk of freezing is confirmed.

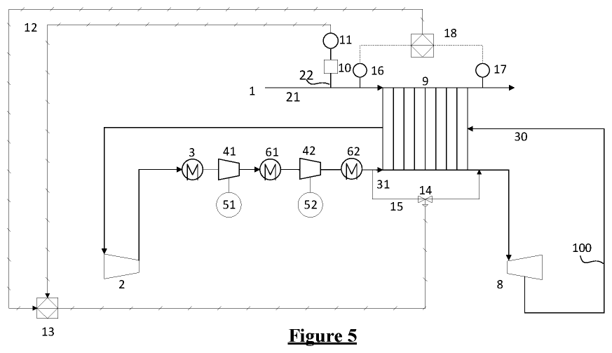

FIG. 5 schematically shows a fifth embodiment of the invention, which is essentially, based on the third embodiment, with the addition of means 16; 17; 18 for measuring the pressure drop across the cryogenic heat exchanger on the side of the cryogenic fluid stream as per the fourth embodiment. The pressure drop across the cryogenic heat exchanger 9 is measured by subtracting with differential pressure transmitter 18 the pressure at the outlet of the passage of the cryogenic fluid in the cryogenic heat exchanger 9 from pressure probe 17 to the pressure at the inlet of the passage of the cryogenic fluid in the cryogenic heat exchanger 9 from pressure probe 16. The differential pressure measured by the pressure transmitter 18 is then transmitted to and used by the computing means 13 for determining the risk of freezing of the cryogenic fluid inside the cryogenic heat exchanger. This additional measurement of the pressure drop across the heat exchanger 9, being independent from the measurement of a physical property of a cryogenic fluid, acts as a second layer of protection against freezing of the cryogenic fluid inside the cryogenic heat exchanger. As in the fourth embodiment, the normalized value of the pressure drop can then be compared to the normalized value of the at least one physical property of the cryogenic fluid to avoid false positives thus rendering the method more reliable.

### LIST OF REFERENCE SIGNS

1 Cryogenic fluid
2; 41; 42 Compressors for the refrigerant
3; 61; 62 Aftercoolers
51; 52 Variable frequency drives
8 Expansion means
9 Cryogenic heat exchanger
10 Gas conditioning system
11 Properties transmitter
12 Means for transmitting at least one physical property
13 Computing means
14 Bypass valve
15 Bypass line
16; 17; 18 Means for measuring pressure drop
21 LNG line from cryogenic tank
22 Line to vaporizing component
30 First refrigerant stream entering the cryogenic heat exchanger to indirectly exchange heat with the cryogenic fluid stream
31 Partial stream of the high-pressure refrigerant
100 Closed refrigeration cycle

1. A method for avoiding freezing of at least one component of a cryogenic fluid stream inside a cryogenic heat exchanger indirectly exchanging heat with a first refrigerant stream circulating inside a closed refrigeration cycle and entering the cryogenic heat exchanger after expansion through at least one expansion means of the closed refrigeration loop to indirectly exchange heat with the cryogenic fluid, the cryogenic fluid stream being different from the first refrigerant stream, and comprising the steps of:
withdrawing and vaporizing a partial stream of the cryogenic fluid stream which is to be fed into the cryogenic heat exchanger;
measuring at least one physical property of a vaporized partial stream of the cryogenic fluid stream, the at least one physical property measured being an indirect indicator of the risk of freezing of the at least one component of the cryogenic fluid stream inside the cryogenic heat exchanger; Transmitting a measurement of the at least one physical property to computing means;
determining by the computing means if there is a risk of freezing of the at least one component of the cryogenic fluid stream inside the cryogenic heat exchanger based on the transmitted measurement;
if the risk of freezing is confirmed, increasing the temperature of the first refrigerant stream entering the heat exchanger to indirectly exchange heat with the cryogenic fluid stream.

2. The method according to claim 1, wherein the risk of freezing of the at least one component of the cryogenic fluid Is confirmed if the transmitted measurement is within a freezing range calculated by the computing means at the temperature of the first refrigerant stream entering the cryogenic heat exchanger to indirectly exchange heat with the cryogenic fluid.

3. The method according to claim 1, wherein the at least one physical property is chosen from a group comprising the thermal conductivity, the speed of sound, the density, the electrical conductivity, the Wobbe index, the heating value.

4. The method according to claim 1, wherein the temperature of the first refrigerant stream entering the cryogenic heat exchanger to indirectly exchange heat with the cryogenic fluid stream is increased by decreasing the mass flow of the first refrigerant stream circulating within a closed loop and entering the cryogenic heat exchanger to indirectly exchange heat with the cryogenic fluid stream.

5. The method according to claim 4, wherein the mass flow of the first refrigerant stream entering the cryogenic heat exchanger to indirectly exchange heat with the cryogenic fluid is decreased by decreasing the speed of rotation of at least one compressor which forces the first refrigerant stream into the cryogenic heat exchanger, in particular which circulates the first refrigerant stream within the closed refrigeration loop comprising the cryogenic heat exchanger.

6. The method according to claim 1, wherein the temperature of the first refrigerant stream entering the heat exchanger is increased by bypassing around the cryogenic heat exchanger a partial stream of a second refrigerant stream which enters the heat exchanger at a pressure higher than the pressure of the first refrigerant stream, both first and second refrigerant streams being circulated within the same closed refrigeration loop.

7. The method according to claim 1, wherein the pressure drop across the cryogenic heat exchanger on the side of the cryogenic fluid stream is measured, transmitted to the computing means and used for determining the risk of freezing of the at least one component of the cryogenic fluid stream inside the cryogenic heat-exchanger.

8. A system comprising a cryogenic heat exchanger, a compressor and computing means for avoiding freezing of at least one component of a cryogenic fluid stream inside the cryogenic heat exchanger indirectly exchanging heat with a first refrigerant stream entering the cryogenic heat exchanger to indirectly exchange heat with the cryogenic fluid, comprising:
a gas conditioning system for vaporizing a partial stream being withdrawn from the cryogenic fluid stream upstream of the heat exchanger
a gas properties transmitter configured to measure at least one physical property of the cryogenic fluid, the at least one physical property being an indirect indicator of the risk of freezing of at least one component of the cryogenic fluid stream inside the cryogenic heat exchanger;
means for transmitting a measurement of the at least one physical property measured by the gas properties transmitter to the computing means configured to determine the risk of freezing of the at least one component of the cryogenic fluid stream inside the cryogenic heat exchanger from the transmitted measurement of the at least one physical property of the cryogenic fluid steam;
means for increasing the temperature of the first refrigerant stream entering the cryogenic heat exchanger to indirectly exchange heat with the cryogenic fluid stream.

9. The system according to claim 8, wherein the at least one physical property measured by the gas properties transmitter is chosen from a group comprising the thermal conductivity, the speed of sound, the density, the electrical conductivity, the Wobbe index, the heating value.

10. The system according to claim 8, wherein the means for increasing the temperature of the first refrigerant stream comprise at least one variable frequency drive for adjusting the speed of rotation of at least one compressor which forces the first refrigerant stream into the cryogenic heat exchanger, in particular which circulates the refrigerant stream inside a closed refrigeration loop comprising the heat exchanger.

11. The system according to claim 8, wherein the means for increasing the temperature of the first refrigerant stream comprise a bypass line with a by-pass valve adapted for bypassing a partial stream of a second refrigerant stream around the cryogenic heat exchanger, both first and second refrigerant streams being circulated within the same closed refrigeration loop.

12. The system according to claim 8, further comprising means for measuring the pressure drop across the cryogenic heat exchanger on the side of the cryogenic fluid stream, the computing means being configured for using the pressure drop across the cryogenic heat exchanger on the side of the cryogenic fluid stream to determine the risk of freezing of the at least one component of the cryogenic fluid stream inside the cryogenic heat exchanger.

13. A use of the method according to claim 1 onboard a sea-going LNG carrier.

14. A ship comprising a system according to claim 8.

15. The ship according to claim 14, the ship being a LNG carrier.
